(19) United States
(12) Patent Application Publication
(10) Pub. No.: US 2022/0042666 A1
(43) Pub. Date: Feb. 10, 2022

(54) LIGHTING DEVICE

(71) Applicant: SHARP KABUSHIKI KAISHA, Sakai City, Osaka (JP)

(72) Inventors: SHUMPEI NISHINAKA, Sakai City, Osaka (JP); KYOKO MATSUURA, Sakai City, Osaka (JP); TOSHIYUKI NOBUOKA, Sakai City, Osaka (JP); SHUN UEKI, Sakai City, Osaka (JP); TSUYOSHI KAMADA, Sakai City, Osaka (JP)

(21) Appl. No.: 17/276,062

(22) PCT Filed: Sep. 6, 2019
(86) PCT No.: PCT/JP2019/035238

§ 371 Date: Mar. 12, 2021

(30) Foreign Application Priority Data
Sep. 14, 2018 (JP) 2018-172474

(51) Int. Cl. F21S 11/00; F21V 5/02; F21V 17/10

(52) U.S. Cl. CPC F21S 11/007; F21V 17/105; F21V 5/02

(57) ABSTRACT

A lighting device includes a lighting film including a prism layer that emits incident light in a prescribed direction, and a rigid body that includes a receiving unit having a prescribed cross-sectional rigidity and supporting the lighting film, and a retaining unit that fixes the lighting film to the receiving unit.

### TECHNICAL FIELD

The present invention relates to a lighting device.

The present application claims priority to Japanese Patent Application 2018-172474 filed in Japan on Sep. 14, 2018, of which contents are incorporated herein by reference.

### BACKGROUND ART

PTL 1 discloses a lighting panel 10 in which a plurality of unit prisms 15 are arranged in a plate-shaped panel 11 such as a glass plate and layered as a polarization layer 14.

### CITATION LIST

### Patent Literature

PTL 1: JP 2012-156554 A

### SUMMARY OF INVENTION

### Technical Problem

However, in the configuration described in PTL 1, the polarization layer in which the unit prisms are arranged is integrated with the panel as one component. Therefore, for example, when the unit prism deteriorates, the panel and the polarization layer cannot be separated.

One aspect of the present invention has been made in view of the problem of the conventional technology described above, and an object of the present invention is to provide a lighting device which allows a panel and a lighting film to be separated from each other.

### Solution to Problem

In order to solve the above problem, a lighting device of one aspect of the present invention includes a lighting film having a prism layer that emits incident light in a prescribed direction, and a rigid body that includes a receiving unit having a prescribed cross-sectional rigidity and supporting the lighting film, and a retaining unit that fixes the lighting film to the receiving unit.

### Advantageous Effects of Invention

According to one aspect of the present invention, a lighting device which allows a panel and a lighting film to be separated from each other can be provided.

### BRIEF DESCRIPTION OF DRAWINGS

FIG. 1 is a top perspective view illustrating a room to which a lighting device according to one aspect of the present invention is applied.

FIG. 2 is a schematic cross-sectional view taken along line II-II of FIG. 1.

FIG. 3 is a schematic view illustrating a configuration of a lighting device according to a first embodiment.

FIG. 4 is a schematic cross-sectional view taken along line IV-IV of FIG. 3.

FIG. 5 illustrates schematic side views illustrating configurations of lighting films.

FIG. 6 illustrates schematic cross-sectional views illustrating configurations of lighting devices.

FIG. 7 illustrates schematic views illustrating shapes of functional films.

FIG. 8 illustrates enlarged views of an area V in FIG. 4.

FIG. 9 is a schematic view illustrating a configuration of another lighting device according to the first embodiment.

FIG. 10 is a schematic cross-sectional view taken along line X-X of FIG. 9.

FIG. 11 is a schematic view illustrating a configuration of a lighting device according to a second embodiment.

FIG. 12 is an enlarged view of a periphery of holes of FIG. 11.

FIG. 13 illustrates enlarged views of a periphery of holes according to another configuration of the second embodiment.

FIG. 14 illustrates schematic views to illustrate shapes and locations of holes.

FIG. 15 is a relationship diagram depicting a relationship between illuminance in a room to which a lighting device according to one aspect of the present invention is applied and a distance from a panel.

### DESCRIPTION OF EMBODIMENTS

Hereinafter, embodiments of the present invention will be described with reference to the drawings.

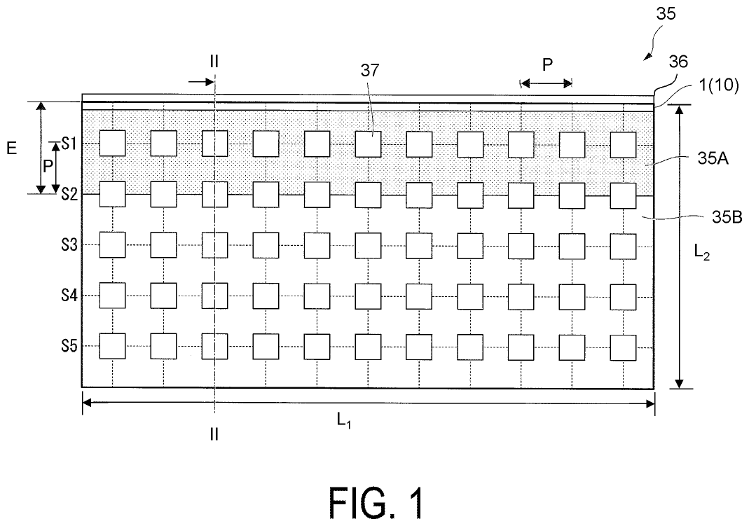

FIG. 1 is a top perspective view illustrating a room 35 in which a lighting device 1 or 10 described later according to one aspect of the present invention is applied. As illustrated in FIG. 1, a panel 36 on which a lighting device 1 or 10 is installed is provided on a side of the room 35, and a ceiling 35B at the upper part of the interior of the room 35 is provided with indoor lighting devices 37 each arranged at a distance P in the long side direction and the short side direction as in rows S1 to S5. Note that the panel 36 and the lighting device 1 or 10 are fixed by fixing tools such as bolts and nuts so that the fixing can be released.

The panel 36 is, for example, a translucent plate-shaped glass or resin used for windows of buildings and vehicles. A light reflecting ceiling material 35A is provided in an area E of the ceiling 35B within a prescribed distance from the panel 36.

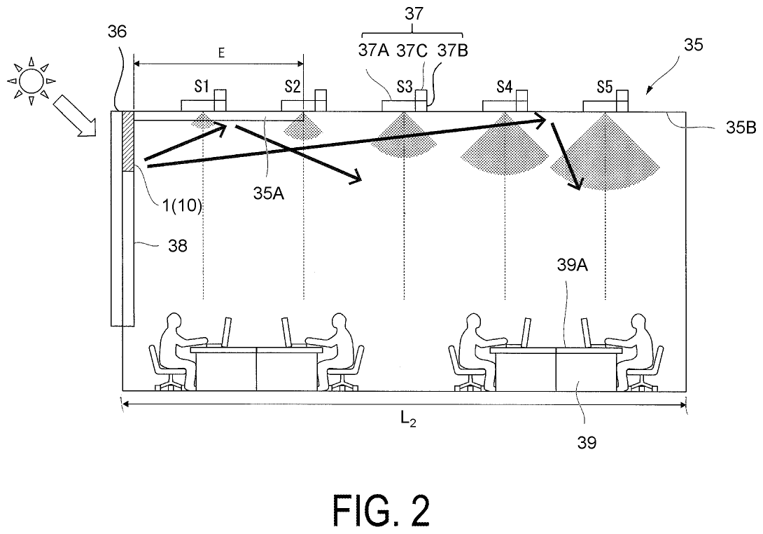

As illustrated in the schematic cross-sectional view of FIG. 2, the panel 36 is provided with a sunlight adjusting device 38 such as blinds in addition to the lighting device 1 or 10. In addition, for example, a desk 39 is installed in the room 35, and the illuminance on a desk surface 39A, which is the top surface of the desk 39, is measured when measuring the illuminance described later.

The light reflecting ceiling material 35A preferably has a diffuse reflectivity that brightens the interior of the room 35 (e.g., the desk surface 39A) and has a specular reflectivity that suppresses the generation of glare light in the room 35. The light reflecting ceiling material 35A may be a material obtained by embossing a metal plate having specular reflectivity such as aluminum, with irregularities of approximately several tens of μm so as to have diffuse reflectivity.

The light reflecting ceiling material 35A may be a material in which a metallic thin film such as aluminum having specular reflectivity is vapor-deposited on the surface of a resin plate that has been embossed with irregularities of approximately several tens of μm so as to have diffuse reflectivity.

Note that the irregularities due to the embossing is preferably approximately several tens of μm, but embossing may be formed into a curved surface with a period larger than several tens of μm. By appropriately changing the shape of the embossing, luminous intensity distribution characteristics, light distribution characteristics, and the like can be changed.

For example, by forming the shape of the embossing applied to the light reflecting ceiling material 35A into a stripe shape that goes toward the back of the room (in the short side direction in FIG. 1), light is guided to the back of the room, and the light reflected by the light reflecting ceiling material 35A is diffused in the long side direction in FIG. 1. For example, when the size and orientation of the panel 36 are limited, it is effective to change the shape of the embossing applied to the light reflecting ceiling material 35A.

In this way, the light reflecting ceiling material 35A can reflect light that has passed through the panel 36 and the lighting device 1 or 10 to guide the light to a place away from the panel 36 inside the room 35.

As illustrated in the schematic cross-sectional view of FIG. 2, the indoor lighting device 37 is a device that illuminates the interior of the room 35, and is configured by an indoor lighting fixture 37A, an illuminance sensing unit 37B, and a controller 37C. The indoor lighting fixture 37A may be a light emitting diode and the like, and a plurality of indoor lighting fixtures 37A may be provided for each indoor lighting device 37.

The illuminance sensing unit 37B is, for example, an illuminance sensor that detects illuminance, which is the brightness of the indoor lighting fixture 37A, and the same number of illuminance sensing units 37B as the indoor lighting fixtures 37A are provided. The illuminance sensing unit 37B receives the light that is emitted by the indoor lighting fixture 37A and reflected from the surface to be illuminated, thereby detecting the illuminance of the surface to be illuminated (for example, the desk surface 39A).

One each of the controller 37C is provided for each indoor lighting device 37, and the adjacent controllers 37C are coupled to each other in order to share a value such as a target illuminance L₀ on the desk surface 39A as a target, for example. The target illuminance L₀ is, for example, the recommended maintained illuminance 7501x in the office according to “JIS Z9110 General rules of recommended lighting levels”. Note that when calculating the illuminance, for example, the illuminance for each area of the desk surface 39A is averaged.

The controller 37C acquires the illuminance detected by the illuminance sensing unit 37B, and performs feedback control for adjusting the illuminance of the corresponding indoor lighting fixture 37A based on the acquired illuminance. By the controller 37C performing the feedback control, the illuminance due to light such as natural light that has passed through the panel 36 and the lighting device 1 or 10 inside the room 35 can be acquired, and the illuminance in each area inside the room 35 can be set as a prescribed value, respectively.

Note that the example illustrated in FIGS. 1 and 2 is an example in which the lighting device 1 or 10 is used. For example, it is naturally preferable to install the lighting device 1 or 10 on the panel 36 without using the indoor lighting device 37.

### First Embodiment

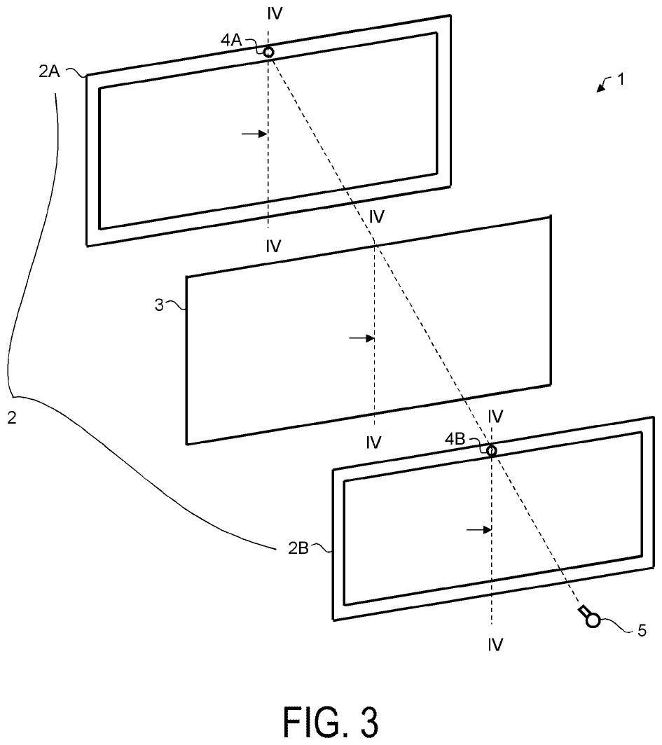

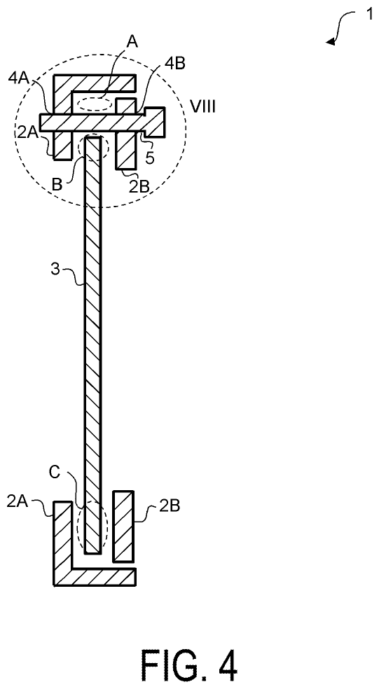

FIG. 3 is a schematic view illustrating a configuration of the lighting device 1 according to the present embodiment. Further, FIG. 4 is a schematic cross-sectional view taken along line IV-IV of FIG. 3. The lighting device 1 includes a lighting film 3 including a prism layer that emits incident light in a prescribed direction, and a rigid body 2 that includes a receiving unit 2A that supports the lighting film 3 and a retaining unit 2B that fixes the lighting film 3 to the receiving unit 2A.

The receiving unit 2A and the retaining unit 2B (hereinafter, these may be referred to as the rigid body 2) are, for example, quadrangular frames, and are fixed with a screw 5 including a protruding portion, which is a fixing tool capable of releasing the fixing. The receiving unit 2A and the retaining unit 2B are provided with circular holes 4A and 4B that match the shape of the protruding portion of the screw 5 so that the protruding portion of the screw 5 passes through. The receiving unit 2A is, for example, an angle member made of aluminum, and the retaining unit 2B is, for example, a flat member having a plate-like cross-section made of aluminum.

The lighting film 3 is not provided with a hole, and the holes 4A and 4B for passing through the screw 5 are provided only in the vicinity of the center of the upper portion of the rigid body 2, and the lighting film 3 is fixed to the rigid body 2 by pressing overlapping areas B and C of the receiving unit 2A, the retaining unit 2B, and the lighting film 3 with the screw 5. By providing the lighting film 3 with a prescribed rigidity, the shape of the surface can be easily maintained when fixed to the rigid body 2.

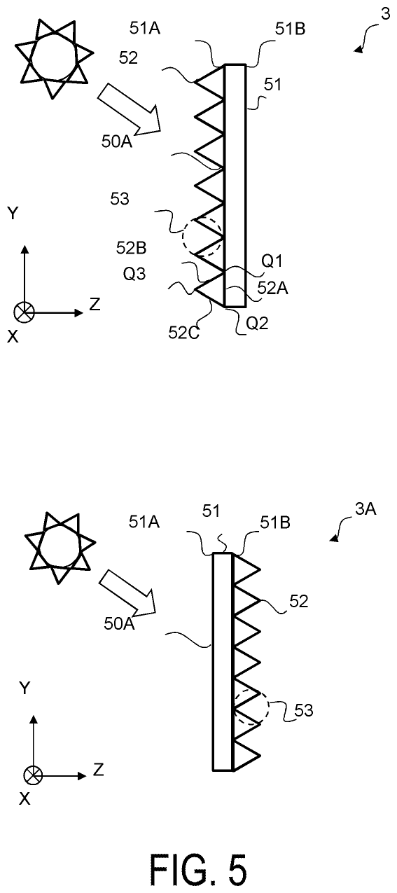

As illustrated in a schematic side view illustrating a configuration of the lighting film 3 in FIG. 5, the lighting film 3 includes a base 51, a plurality of lighting units 52 having light transparency provided on a first surface 51A of the base 51, and a gap portion 53 provided between the plurality of lighting units 52. In the present embodiment, the lighting film 3 is provided with a surface (light incident surface 50A) having a fine structure constituted by a plurality of lighting units 52 facing a side into which light such as sunlight enters.

The base 51 is made of a light transmitting resin such as a thermoplastic polymer, a thermosetting resin, or a photopolymerizable resin. For example, the base 51 is made of an acrylic polymer, an olefin polymer, a vinyl polymer, a cellulose polymer, an amide polymer, a fluorine polymer, a urethane polymer, a silicone polymer, or an imide polymer.

Note that the base 51 is preferably a polymethyl methacrylate resin (PMMA), triacetyl cellulose (TAC), polyethylene terephthalate (PET), cycloolefin polymer (COP), polycarbonate (PC), polyethylene naphthalate (PEN), polyether sulfone (PES), polyimide (PI), or the like. In addition, the total light transmittance of the base 51 is preferably 90% or more in accordance with JIS K7361-1. Thus, sufficient transparency can be obtained.

The lighting unit 52 is made of an organic material having light transparency and photosensitivity, such as acrylic resin, epoxy resin, or silicone resin. Further, for the lighting unit 52, a mixture of these organic materials with a polymerization initiator, a coupling agent, a monomer, an organic solvent, and the like can be used. Note that the polymerization initiator may include various additive components such as stabilizers, inhibitors, plasticizers, optical brighteners, mold release agents, chain transfer agents, and other photopolymerizable monomers.

Further, as the lighting unit 52, the material described in JP 4129991 B can be used. Since the lighting unit 52 preferably has sufficient transparency, the total light transmittance of the lighting unit 52 is preferably 90% or more in accordance with JIS K7361-1.

The plurality of lighting units 52 extend in the long side direction (X-axis direction) of the base 51, and are provided side by side in the short side direction (Y-axis direction) of the base 51. Further, each lighting unit 52 constitutes a prism body having, for example, a triangular cross-section. Note that the cross-section of each lighting unit 52 is not limited to a triangle, but may be a quadrangle or a polygon of a pentagon or more.

The lighting unit 52 has a first surface portion 52A facing the first surface 51A of the base 51, and a second surface portion 52B adjacent to the first surface portion 52A with a first corner portion Q1 interposed therebetween. The lighting unit 52 has a third surface portion (reflective surface: side surface) 52C adjacent to the first surface portion 52A with a second corner portion Q2 on the opposite side to the first corner portion Q1 interposed therebetween, and adjacent to the second surface portion 52B with a third corner portion Q3 interposed therebetween.

Here, since the gap portion 53 (air exists) is provided between the adjacent lighting units 52, the second surface portion 52B and the third surface portion 52C serve as interfaces between the constituent material of the lighting unit 52 and air. The gap portion 53 may be filled with a material with a low refractive index different from that of air.

Note that the refractive index difference at the interface between the inside and the outside of the lighting unit 52 is maximum when air is present in the gap portion 53 rather than when the gap portion 53 is filled with the low refractive index material. Therefore, when air is present, according to Snell's law, the critical angle of the light totally reflected by the second surface portion 52B or the third surface portion 52C is the smallest of the light incident on the lighting unit 52.

Thus, the range of the incident angle, which is the angle at which the light totally reflected by the second surface portion 52B or the third surface portion 52C enters, becomes the widest, so that light incident on the lighting unit 52 can be efficiently guided to another surface side of the base 51. As a result, the loss of the light entering the lighting unit 52 is suppressed, and the brightness of the light emitted from a second surface 51B of the base 51 can be increased. As described above, the lighting film 3 has a lighting function to enhance the brightness of the emitted light.

It is desirable that the refractive index of the base 51 and the refractive index of the lighting unit 52 be approximately the same. For example, in a case where the refractive index of the base 51 and the refractive index of the lighting unit 52 are greatly different, when light enters the base 51 from the lighting unit 52, undesired refraction or reflection of light may occur at the interface between the lighting unit 52 and the base 51. In this case, problems such as not being able to obtain desired lighting characteristics and a decrease in brightness may occur.

As a method for manufacturing the lighting film 3, a plurality of lighting units 52 can be formed on the base 51 using a photolithography technique, for example. In addition to the method using the photolithography technique, the lighting film 3 can be manufactured by a method such as a melt extrusion method, a die extrusion method, or an imprint method. In the methods such as the melt extrusion method and the die extrusion method, the base 51 and the lighting unit 52 are integrally formed of the same resin as one component.

Further, as a method for manufacturing the lighting film 3, the lighting unit 52 may be formed on one face of a film, and the film may be attached to the first surface 51A of the base 51. As the method of forming the lighting unit 52 on one surface of the film, the above-mentioned photolithography technique, the imprint method, or the like can be used.

In the lighting film 3 of FIG. 5, the first surface 51A of the base 51 provided with the plurality of lighting units 52 is directed to the side on which light enters (hereinafter. may be referred to as a window side). However, the present embodiment is not limited to this configuration. For example, as illustrated in a lighting film 3A, the plurality of lighting units 52 may be provided on the second surface 51B side of the base 51, and a surface having a fine structure constituted by the plurality of lighting units 52 (light emitting surface 50B) may be directed to the indoor side where sunlight or the like is emitted.

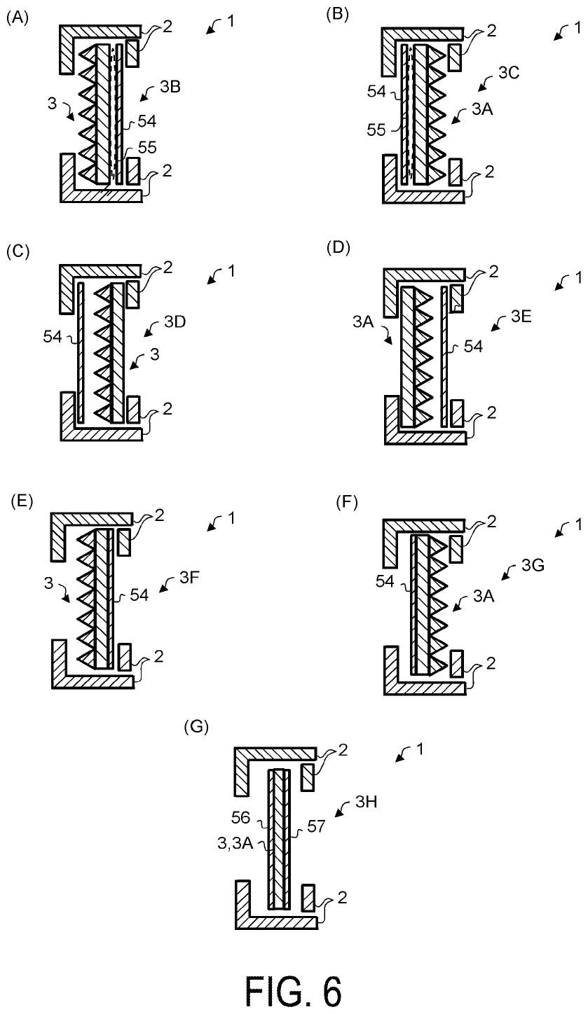

Further, although the case in which the lighting film 3 or 3A is used as a single film having a lighting function has been described in FIG. 5, the present embodiment is not limited thereto. As illustrated in the lighting film units 3B to 3F of the schematic cross-sectional views (A) to (F) illustrating the configuration of the lighting device 1 in FIG. 6, the configuration of the lighting device 1 may be further provided with a diffusion film 54 that diffuses and emits the incident light.

Note that the schematic cross-sectional views (A) to (F) of FIG. 6 correspond to the cross-sectional view taken along line IV-IV of FIG. 3, and examples are illustrated in which the material of the receiving unit 2A is a magnetic material such as iron, and the material of the retaining unit 2B is a magnet, which will be described later. When the diffusion film 54 is provided, the lighting film 3 or 3A, and the diffusion film 54 are retained by the rigid body 2.

As the diffusion film 54, it is desirable to have an anisotropic light scattering characteristics that spread light mainly in the long side direction of the lighting film 3 or 3A (X-axis direction), which is the longitudinal direction, and that does not spread so much in the short side direction (Y-axis direction) of the lighting film 3 or 3A, which is the vertical direction.

When the diffusion film 54 has a structure having anisotropic light diffusion characteristics, brightness can be made uniform in the horizontal direction in the room. Note that examples of structure having light diffusion characteristics include a lenticular lens structure, a light diffusion particle structure, and a pseudo-stripe structure.

The lighting film units 3B, 3D, and 3F illustrated in the schematic cross-sectional views (A), (C), and (E) of FIG. 6 have a configuration in which the diffusion film 54 having a shape similar to that of the lighting film 3 is added to the lighting film 3. In the lighting film unit 3B illustrated in the schematic cross-sectional view (A) of FIG. 6, a gap portion 55 and the diffusion film 54 are provided on the side where light is emitted from the lighting film 3 with the lighting units 52 facing the side where light enters. In the lighting film unit 3D illustrated in the schematic cross-sectional view (C) of FIG. 6, the diffusion film 54 is provided on the side where light enters the lighting film 3. In the lighting film unit 3F illustrated in the schematic cross-sectional view (E) of FIG. 6, the diffusion film 54 is provided adjacent to the lighting film 3 on the side where light is emitted from the lighting film 3.

The lighting film units 3C, 3E, and 3G illustrated in the schematic cross-sectional views (B), (D), and (F) of FIG. 6 have a configuration in which the diffusion film 54 is added to the lighting film 3A. In the lighting film unit 3C illustrated in the schematic cross-sectional view (B) of FIG. 6, the gap portion 55 and the diffusion film 54 are provided on the side where light enters the lighting film 3A with the lighting units 52 facing the side where the light is emitted. In the lighting film unit 3E illustrated in the schematic cross-sectional view (D) of FIG. 6, the diffusion film 54 is provided on the side where light is emitted from the lighting film 3A. In the lighting film unit 3G illustrated in the schematic cross-sectional view (F) of FIG. 6, the diffusion film 54 is provided adjacent to the lighting film 3A on the side where light enters the lighting film 3A.

Since the light emitted through the lighting unit 52 is diffused by the diffusion film 54, the lighting film units 3B, 3E, and 3F illustrated in the schematic cross-sectional views (A), (D), and (E) of FIG. 6 can emit light in which glare light is suppressed. Also, in the lighting film units 3C, 3D, and 3G illustrated in the schematic cross-sectional views (B), (C), and (F) of FIG. 6, since the light enters the lighting unit 52 after being diffused by the diffusion film 54, the lighting film units 3C, 3D, and 3G can emit light in which glare light is suppressed.

Note that the gap portion 55 may be provided when structurally necessary, and does not affect the effect provided by the present embodiment. Additionally, for example, in the lighting film units 3B and 3F illustrated in the schematic cross-sectional views (A) and (E) of FIG. 6, instead of the diffusion film 54, as a functional film, a UV cut film that reduces ultraviolet rays included in the light to be emitted with respect to the incident light or a heat shielding film that blocks heat may be provided.

In addition, in the lighting film unit 3B or 3C illustrated in the schematic cross-sectional view (A) or (B) of FIG. 6, the lighting film 3 or 3A, and the diffusion film 54 are separate films, but the present embodiment is not limited thereto. In the lighting film 3 or 3A, by providing a diffusing portion having a similar structure to that of the diffusion film 54 that diffuses light on a surface opposite to the surface on which the lighting units 52 are provided, a single film may be formed.

In addition, in the schematic cross-sectional views (A) to (F) of FIG. 6, a case has been described in which a film such as the diffusion film 54 is provided on one side of the lighting film 3 or 3A, the present embodiment is not limited thereto. Functional films 56 and 57 having specific functions may be provided on each side of the lighting film 3 or 3A like the lighting film unit 3H illustrated in the schematic cross-sectional view (G) of FIG. 6. The functional films 56 and 57 may be protective films using polyethylene terephthalate (PET), polycarbonate (PC), transparent acrylic plate, or the like that protects the lighting film 3 or 3A from impact, dust, and the like.

The functional film 56 may be used as a protective film, and the functional film 57 may be used as a diffusion film so as to protect the lighting film 3 or 3A while suppressing the generation of glare light. Additionally, the functional film 56 may be used as a UV cut film, and the functional film 57 may be used as a design film so that a gorgeous atmosphere can be created, and the ultraviolet rays can be suppressed while ensuring the illuminance by the lighting function of the lighting film 3 or 3A. Note that the design film may be, for example, a protective film printed with a pattern or characters.

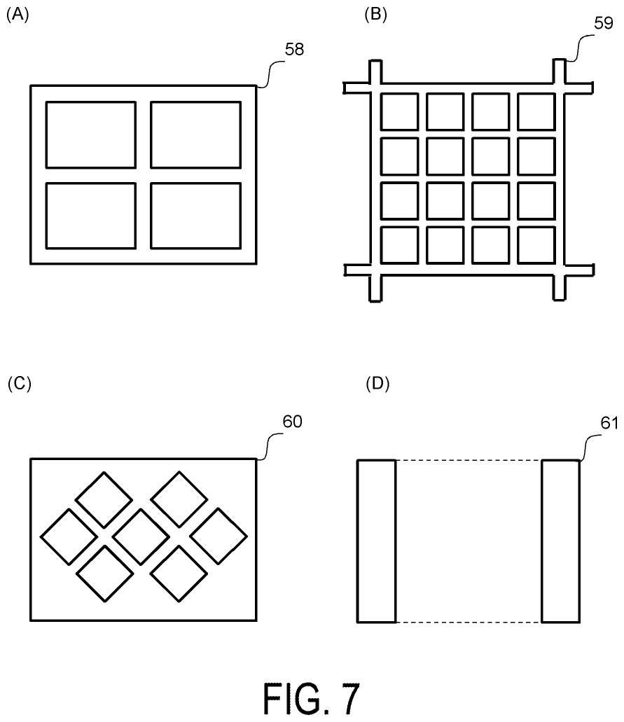

Note that, as illustrated in schematic views (A) to (D) illustrating the shapes of the functional films 58 to 61 of FIG. 7, the functional films 56 and 57 may not have the same shape as the lighting film 3 or 3A, and may be a pair of films having openings or the like having the same shape showing rigidity and may sandwich the lighting film 3 or 3A. As a result, the lighting film 3 or 3A can easily maintain the shape of the surface of the lighting film 3 or 3A as compared with a case where the functional films 56 and 57 are not provided. By not forming the shapes of the functional films 56 and 57 in the same shape as the lighting film 3 or 3A, design properties can be added to the lighting device 1.

For example, as illustrated in the schematic view (A) of FIG. 7, the functional film 58 is made of resin or metal and presses the lighting film 3 or 3A at the entire periphery and the central portion. As illustrated in the schematic view (B) of FIG. 7, the functional film 59 is made of resin or metal and presses the entire surface of the lighting film 3 or 3A in a grid pattern. As illustrated in the schematic view (C) of FIG. 7, the functional film 60 is made of resin and, for example, is provided with a plurality of openings having the same shape such as a rhombus, and presses the entire surface of the lighting film 3 or 3A. As illustrated in the schematic view (D) of FIG. 7, the functional film 61 partially presses the lighting film 3 or 3A.

In this way, in the lighting film units 3B to 3H, a plurality of layered films can be retained and stored by the rigid body 2. Therefore, in addition to the lighting function of the lighting film 3 or 3A, functions such as a function of diffusing light and a function of shielding heat can be easily added to the lighting device 1. Note that when the function is added, the brightness obtained by the lighting function of the lighting device 1 becomes low. Therefore, when adding the function, the balance between the function to be added and the brightness obtained by the lighting function needs to be considered.

Note that, in order not to provide a gap portion A in FIG. 4, a hole 4C described later may be provided on the upper portion of the lighting film 3. Note that the lighting film 3 is described as an example, but the same applies to the lighting film 3A. When the lighting film 3 is not provided with a hole, the strength of the lighting film 3 is greater than when the lighting film 3 is provided with a hole. Note that when the gap portion A is provided, the area where the lighting film 3 is pressed by the retaining unit 2B at the upper portion of the lighting device 1 is smaller than when the gap portion A is not provided. As a result, the force with which the retaining unit 2B presses the lighting film 3 is weakened.

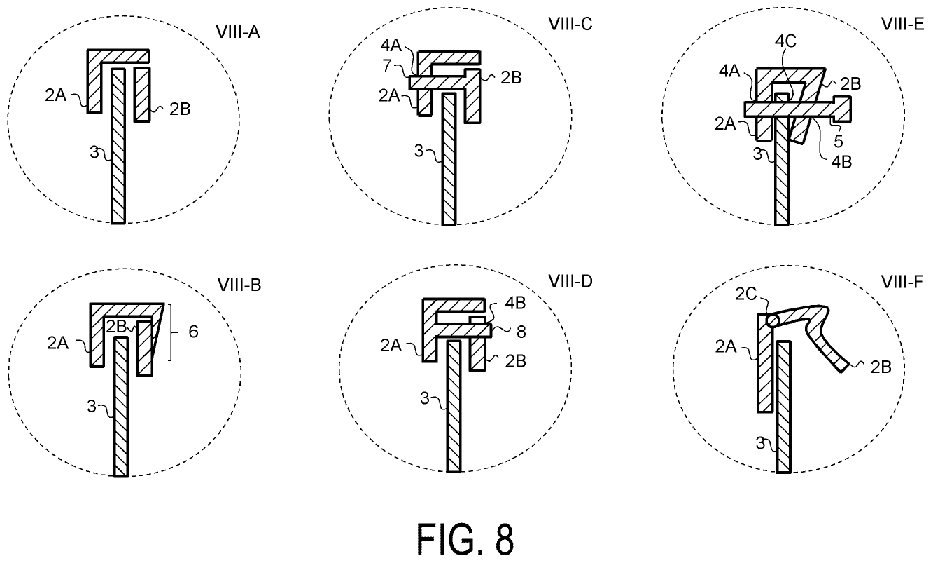

The configuration for the retaining unit 2B to press the lighting film 3 is not limited to the configuration illustrated in FIG. 4. For example, the configurations illustrated in the areas VIII-A, VIII-B, VIII-C, VIII-D, VIII-E, and VIII-F of FIG. 8, which are enlarged views of the area VIII of FIG. 4, may be used.

In FIG. 4, the case in which the receiving unit 2A and the retaining unit 2B are made of aluminum is described, but as illustrated in the area VIII-A of FIG. 8, the material of the receiving unit 2A may be a magnetic material such as iron, and the material of the retaining unit 2B may be a magnet.

Additionally, as illustrated in the area VIII-B of FIG. 8, a retaining portion 6 that presses the retaining unit 2B toward the lighting film 3 may be provided in the receiving unit 2A. For example, the width of a groove of the receiving unit 2A accommodating the lighting film 3 and the retaining unit 2B is made smaller than the size obtained by adding the thickness of the lighting film 3 and the thickness of the retaining unit 2B, and the receiving unit 2A sandwiches the lighting film 3 and the retaining unit 2B.

Additionally, as illustrated in the area VIII-C of FIG. 8, the retaining unit 2B may press the lighting film 3 by a protruding portion 7 provided in the retaining unit 2B passing through the hole 4A provided in the receiving unit 2A.

Also, as illustrated in the area VIII-D of FIG. 8, the retaining unit 2B may press the lighting film 3 by a protruding portion 8 provided in the receiving unit 2A passing through the hole 4B provided in the retaining unit 2B.

Further, as illustrated in the area V-E of FIG. 8, the receiving unit 2A and the retaining unit 2B may be integrated as one unit. In this case, the fixing of the receiving unit 2A and the retaining unit 2B by the screw 5 becomes weaker than that in FIG. 4, and the force of the retaining unit 2B pressing and fixing the lighting film 3 becomes weaker. The hole 4C is provided in the lighting film 3, and the lighting film 3 is fixed to the rigid body 2 with the screw 5 passing through the holes 4A, 4B, and 4C.

Further, as illustrated in the area VIII-F of FIG. 8, the rigid body 2 may be further provided with a rotating portion 2C such as a spring-loaded hinge to fix the lighting film 3.

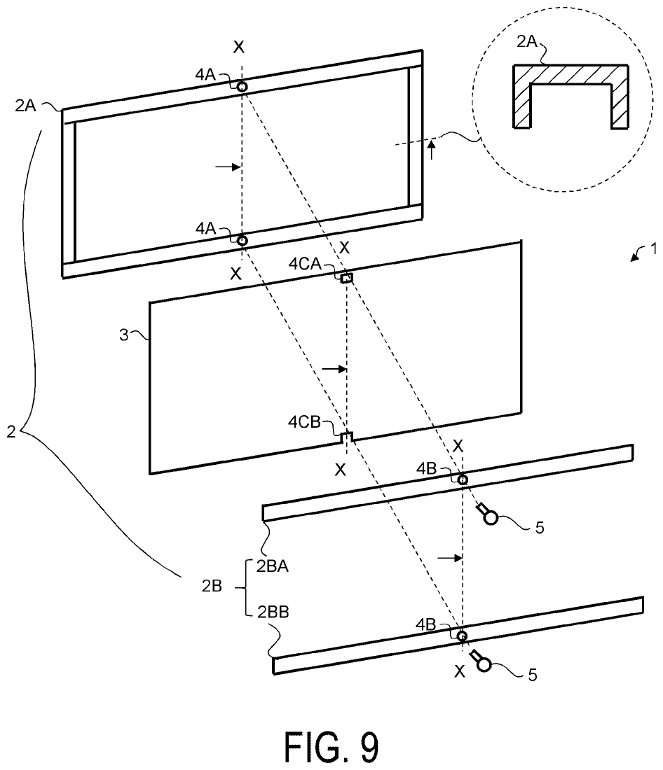

In FIGS. 3, 4, 6, and 8, the receiving unit 2A is the angle member and the retaining unit 2B is the flat member at the entire periphery of the rigid body 2. However, as illustrated in another configuration of the present embodiment of FIG. 9, for example, the cross-section of the side portions of the receiving unit 2A may be C-shaped.

When the cross-section of the side portions of the receiving unit 2A is C-shaped, the retaining unit 2B need not be provided on the entire periphery of the rigid body 2, and for example, an upper retaining unit 2BA and a lower retaining unit 2BB may be provided on the upper portion and the lower portion, respectively. In FIG. 9, the retaining unit 2B is constituted by the upper retaining unit 2BA and the lower retaining unit 2BB.

Since the upper retaining unit 2BA and the lower retaining unit 2BB are separated, the screw 5 as a fixing tool is required for each of the upper retaining unit 2BA and the lower retaining unit 2BB.

Since the area where the retaining unit 2B presses the lighting film 3 is reduced, the fixing between the lighting film 3 and the rigid body 2 is weaker than that of FIG. 3, but the lighting film 3 can move freely as compared with that of FIG. 3. In FIG. 9, the holes 4C are provided near the center of the upper portion and the lower portion of the lighting film 3, and the screw 5 passes through the holes 4A, 4B, 4CA, and 4CB to strengthen the force for fixing the lighting film 3 and the rigid body 2.

The shapes of the holes 4A and 4B are circular to match the shape of the screw 5, but the shape of the hole 4CA provided at the upper portion of the lighting film 3 is a quadrangle, and the shape of the holes 4CB provided at the lower portion is a lower cut. The hole 4CA has a closed shape in order to support the lighting film 3 with the screw 5 passing through the hole 4CA and prevent the lighting film 3 from falling, and has a shape that is straight in the horizontal direction so as to correspond to expansion and contraction of the lighting film 3 due to the influence of heat and the like. The hole 4CB has a shape that is easy to accommodate when the lighting film 3 is accommodated in the rigid body 2, and has a shape that is straight in the horizontal direction so as to correspond to the expansion and contraction of the lighting film 3.

Each side portion of the receiving unit 2A may be provided with a movement suppressing unit using sponge rubber or the like on at least one surface facing the lighting film 3 in order to suppress the movement of the lighting film 3.

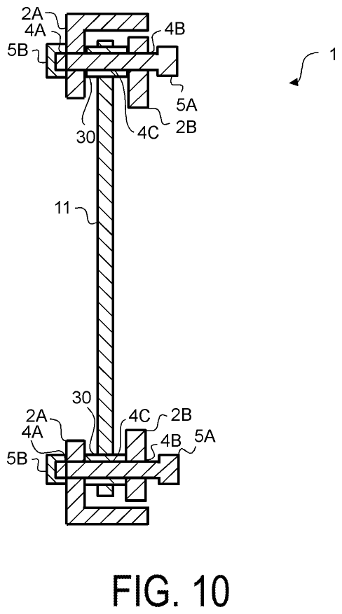

A schematic cross-sectional view taken along line X-X of FIG. 9 is illustrated in FIG. 10. As illustrated in FIG. 10, the fixing tool may be, for example, a bolt 5A and a nut 5B with a nominal diameter of M2 instead of the screw 5. In addition, by providing a spacer 30 such as a nut with a nominal diameter M2 between the receiving unit 2A and the retaining unit 2B, it is possible to prevent the lighting film 3 from being pressed by a prescribed force or higher.

In addition, the spacer 30 having a thickness equal to or greater than the thickness of the lighting film 3 creates a space in the thickness direction of the lighting film 3, so that the lighting film 3 can move. Therefore, the distortion of the lighting film 3 generated when the lighting film 3 expands and contracts can be reduced.

In FIG. 9, the case has been described in which the retaining unit 2B separated into the upper portion and the lower portion of the rigid body 2 is provided, but the same effect as that of FIG. 9 can be obtained by providing the retaining unit 2B separated into each side portion of the rigid body 2 or by providing the retaining unit 2B separated at the four corners of the rigid body 2.

In FIGS. 3, 8 (VIII-B, VIII-C, VIII-D, VIII-E, and VIII-F), and 9, the case in which the material of the rigid body 2 is aluminum has been described, but the materials of the receiving unit 2A and the retaining unit 2B may be different materials.

For example, when the material of the receiving unit 2A is aluminum and the material of the retaining unit 2B is resin, since the expansion and contraction characteristics (for example, the coefficient of thermal expansion which is the coefficient of linear expansion due to heat) of the material of the retaining unit 2B are closer to the expansion and contraction characteristics of the material of the lighting film 3 than the expansion and contraction characteristics of the material of the receiving portion 2A, the retaining unit 2B can follow the expansion and contraction of the lighting film 3.

As described above, in the lighting device 1 according to the present embodiment, instead of fixing the lighting film 3 to the panel 36 with an adhesive or the like, the lighting film 3 is fixed to the rigid body 2 with the fixing tool such as the screw 5 capable of releasing the fixing. In addition, the lighting device 1 including the rigid body 2 is fixed to the panel 36 with the fixing tool such as the bolt and the nut capable of releasing the fixing.

According to the present embodiment, the panel 36 and the lighting film 3 can be separated. In addition, when the lighting film 3 deteriorates, only the lighting film 3 can be replaced.

### Second Embodiment

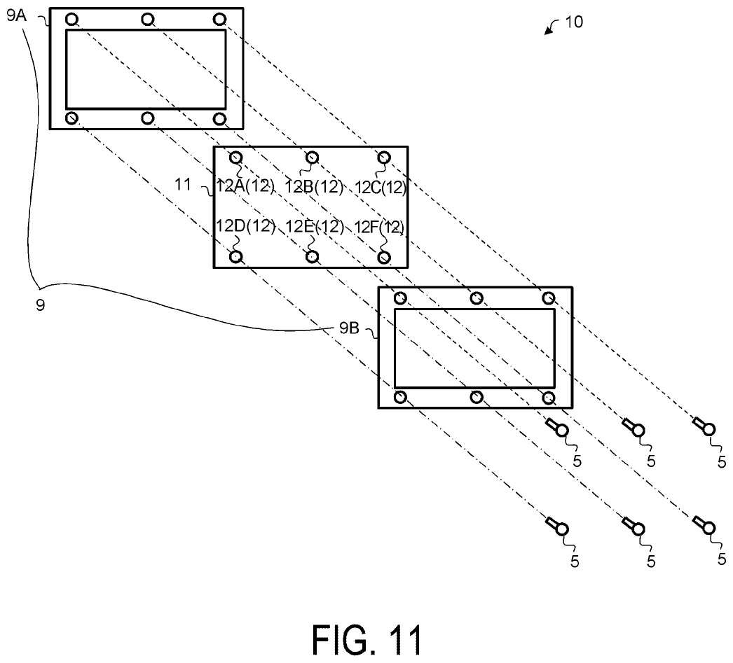

In the first embodiment, the case has been described in which two or less holes 4A and 4B are provided in the rigid body 2, but the number of holes may be three or more, and the holes of the lighting film 3 may also be three or more. In the configuration of the lighting device 10 according to the present embodiment illustrated in FIG. 11, a rigid body 9 is fixed by the screws 5 passing through the holes provided at three locations on the upper side and three locations on the lower side of the rigid body 9 (receiving unit 9A and retaining unit 9B).

Note that the retaining unit 9B fixes a lighting film 11 to the receiving unit 9A by pressing the lighting film 11. Further, the screws 5 pass through circular holes 12 (12A, 12B, 12C, 12D, 12E, and 12F) provided in the lighting film 11, and fix the lighting film 11 to the rigid body 9. The holes 12A, 12B, and 12C are provided at equal distances on the upper side of the lighting film 11, and the holes 12D, 12E, and 12F are provided at equal distances on the lower side of the lighting film 11.

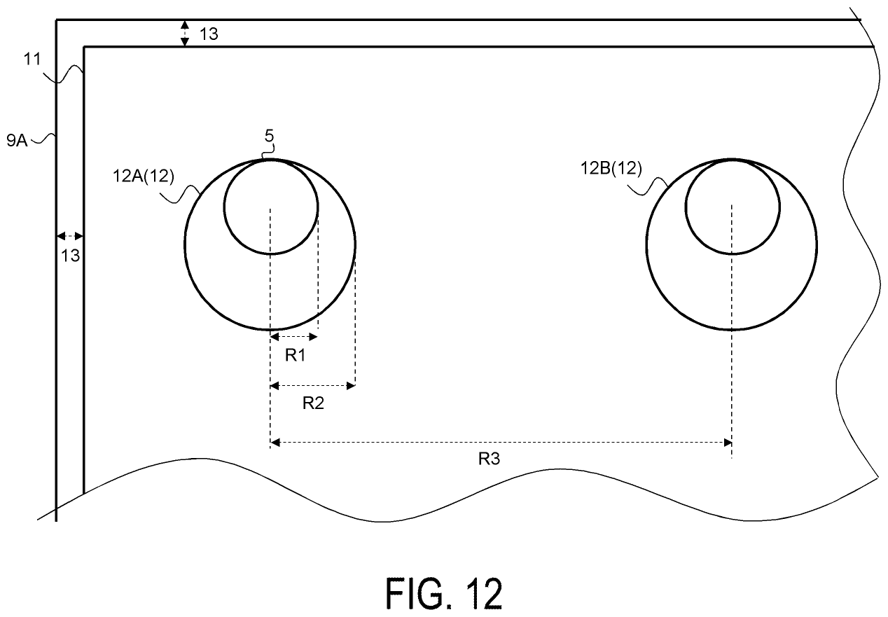

FIG. 12 is an enlarged view of a periphery of the holes 12 of FIG. 11. In order to reduce the distortion caused by the expansion and contraction of the lighting film 11, it is desirable that a radius R2 of the hole 12 be larger than a radius R1 of the screw 5. More desirably, it is desirable to satisfy the following expression when a coefficient of linear expansion of the lighting film 11 is a, a distance between adjacent holes 12 is R3, and a daily maximum difference of the environmental temperature around the panel 36 (subtracting the minimum value from the maximum value) is T. Note that the difference between the radius R2 and the radius R1 is the range of motion of the screw 5 in the horizontal direction.

R2−R1>R3×(α×T) (1)

Additionally, it is desirable to provide a gap portion 13 between the end side of the lighting film 11 and the inner side of the end side of the receiving unit 9A so that the expansion and contraction of the lighting film 11 can be accommodated.

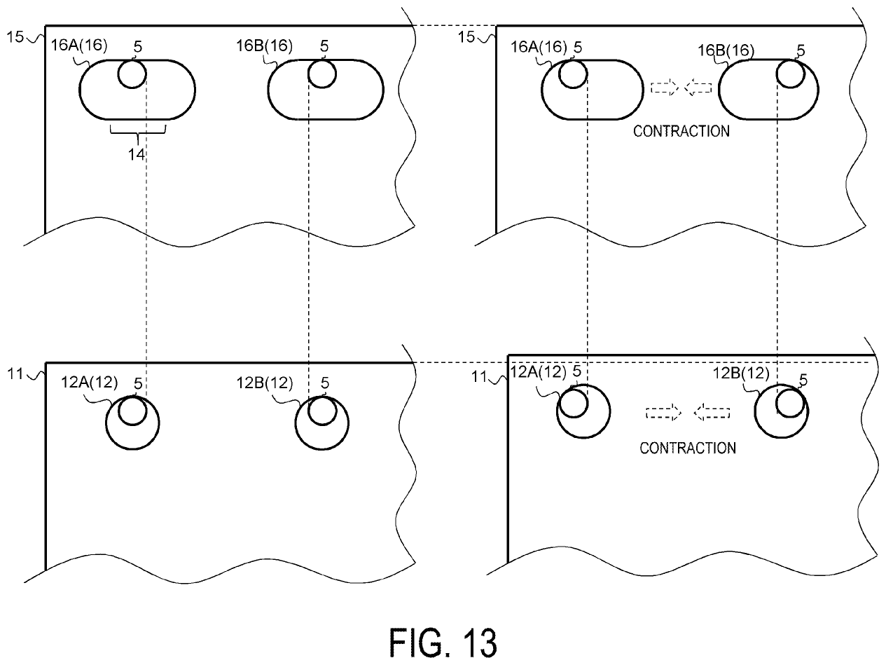

FIG. 13 illustrates enlarged views of a periphery of holes 16 according to another configuration of the present embodiment. The holes 16 (16A and 16B) have shapes having a linear portion 14 along one side in the direction of the expansion and contraction of a lighting film 15. Note that the holes 16 (16A, 16B, 16C, 16D, 16E, and 16F) are provided at the same locations as the holes 12 (12A, 12B, 12C, 12D, 12E, and 12F).

By providing the linear portion 14, it is possible to prevent the position of the upper side of the lighting film 15 from shifting when the lighting film 15 contracts without changing the distance between the adjacent screws 5. Note that in the case where the holes 12 without the linear portion 14 are provided like the lighting film 11, when the lighting film 15 contracts without changing the distance between the adjacent screws 5, the position of the upper side of the lighting film 3 shifts.

In FIG. 11, the lighting film 11 provided with the six circular holes 12 is described, but the hole shape may not be circular and the number of places where holes are provided does not have to be six.

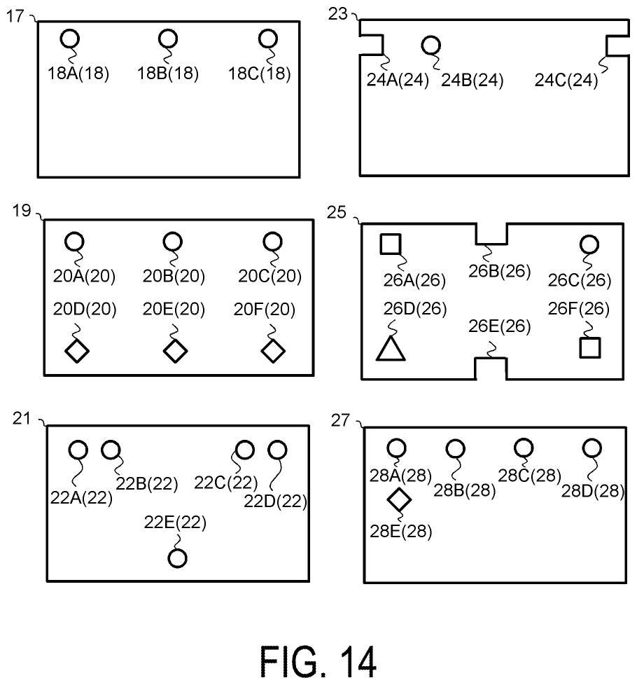

FIG. 14 illustrates schematic views of hole shapes and hole positions. In a lighting film 17, circular holes 18 (18A, 18B, and 18C) are provided at equal distances only on the upper side. Further, in a lighting film 19, circular holes 20 (20A, 20B, and 20C) are provided at equal distances on the upper side, and holes 20 (20D, 20E, and 20F) having a rhombus shape are provided at equal distances on the lower side. Thus, the holes 20 having different shapes are provided on the upper side and the lower side.

In addition, a lighting film 21 is provided so that the positions of circular holes 22 (22A, 22B, 22C, 22D, and 22E) are different between the upper side and the lower side. The holes 22A and 22B and the holes 22C and 22D are provided line-symmetrically on the upper side with the center portion of the upper side as a boundary, and the hole 22E is provided around the center portion on the lower side.

In a case where the hole shapes or the hole positions are non-axisymmetric between the upper side and the lower side as in the lighting film 17, 19, or 21, when the lighting films 17, 19, or 21 is accommodated in the rigid body 9, it is possible to prevent an accident in which the lighting film 17, 19, or 21 is accommodated wrongly with top and bottom reversed.

The lighting film 23 is provided so that the positions of the holes 24 (24A, 24B, and 24C) are different between the left side and the right side with the central portion as a boundary. The shape of the hole 24A is a left cut, the shape of the hole 24B is circular, and the shape of the hole 24C is a right cut. The hole 24A and the hole 24C are provided line-symmetrically with the central portion of the upper side as a boundary, and the hole 24B is provided on the left side with respect to the central portion.

A lighting film 25 is provided so that the shapes of the holes 26 (26A, 26B, 26C, 26D, 26E, and 26F) are different between the left side and right side with the central portion as a boundary. The shape of the hole 26A is a quadrangle, the shape of the hole 26B is an upper cut, the shape of the hole 26C is a circle, the shape of the hole 26D is a triangle, the shape of the hole 26E is a lower cut, and the shape of the hole 26F is a quadrangle. The holes 26A, 26B, and 26C are provided on the upper side at equal distances, and the holes 26D, 26E, and 26F are provided on the lower side at equal distances.

The lighting film 27 is provided so that the holes 28 (28A, 28B, 28C, 28D, and 28E) are different on the left side and the right side with the central portion as a boundary. The holes 28A, 28B, 28C, and 28D are provided on the upper side at equal distances. The hole 28E is provided below the hole 28A.

In a case where the hole shapes or hole positions are non-axisymmetric between the left side and the right side as in the lighting film 23, 25, or 27, when the lighting film 23, 25, or 27 is accommodated in the rigid body 9, it is possible to prevent an accident in which the lighting film 23, 25, or 27 is accommodated wrongly with front and back reversed.

As described above, the lighting device 10 according to the present embodiment has three or more holes 12, 16, 18, 20, 22, 24, 26, and 28 provided in the lighting films 11, 15, 17, 19, 21, 23, 25, and 27.

As described above, the lighting device 10 according to the present embodiment has three or more holes 18, 20, 22, 24, 26, and 28 provided in the lighting films 17, 19, 21, 23, 25, and 27.

According to the present embodiment, in addition to the effects of the first embodiment, when the lighting films 17, 19, 21, 23, 25, and 27 are accommodated, it is possible to suppress erroneous accommodation of upside down or front-back inversion.

### Third Embodiment

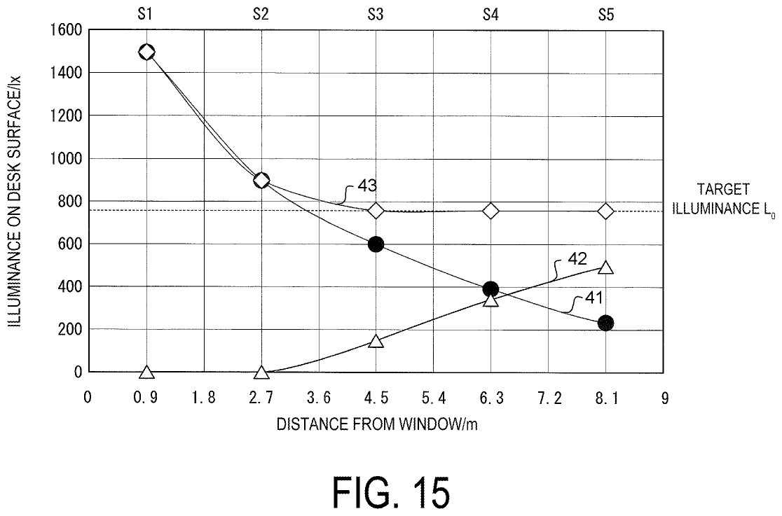

In the present embodiment, a dimming system adopted in the room illustrated in FIG. 1 will be described. In FIG. 1, when the area E is 3 m, a distance P is 1.8 m, a width L₁ of the room 35 is 18 m, and a depth L₂ of the room 35 is 9 m, the relationship between the illuminance of the room 35 and the distance from the panel 36 is as shown in FIG. 15.

In FIG. 15, the graph 41 depicts the illuminance on each desk surface 39A illuminated by the light passing through the panel 36 and the lighting device 1 or 10 and detected by the illuminance sensing unit 37B, the graph 42 depicts the illuminance on each desk surface 39A illuminated by the light from the indoor lighting fixture 37A, and the graph 43 depicts the actual illuminance on each desk surface 39A.

The illuminance sensing unit 37B detects the illuminance on the desk surface 39A, and transmits information of the detected illuminance to the controller 37C. The controller 37C determines whether the illuminance on the desk surface 39A is sufficient for the target illuminance L₀ based on the transmitted illuminance information.

When the controller 37C determines that the illuminance on the desk surface 39A detected by the illuminance sensing unit 37B is insufficient for the target illuminance L₀, the controller 37C controls the indoor lighting fixture 37A so that the indoor lighting fixture 37A emits light corresponding to the insufficient illuminance.

At the time of the next detection, the illuminance sensing unit 37B detects the illuminance on the desk surface 39A illuminated by the indoor lighting fixture 37A, and transmits the information of the detected illuminance to the controller 37C. The controller 37C again determines whether the illuminance on the desk surface 39A is sufficient for the target illuminance L₀ based on the transmitted illuminance information. Such feedback control is performed by the controller 37C.

According to the present embodiment, it is possible to provide a dimming system capable of reducing the illumination by the indoor lighting fixture 37A as compared with the ones in the past, by utilizing natural light, and capable of suppressing the generation of glare light by the effects of the first and second embodiments due to the use of the lighting device 1 or 10.

1. A lighting device comprising:
a lighting film including a prism layer configured to emit incident light in a prescribed direction; and
a rigid body including
a receiving unit having a prescribed cross-sectional rigidity and configured to support the lighting film, and
a retaining unit configured to fix the lighting film to the receiving unit.

2. The lighting device according to claim 1,
wherein the lighting film can be removed by releasing fixing of the lighting film by the retaining unit and the receiving unit.

3. The lighting device according to claim 1,
wherein the receiving unit and the retaining unit are fixed by a fixing tool including a protruding portion configured to pass through a hole provided in the receiving unit and a hole provided in the retaining unit.

4. The lighting device according to claim 1,
wherein the receiving unit includes a retaining portion configured to press the retaining unit toward the lighting film and press the lighting film and the retaining unit.

5. The lighting device according to claim 1,
wherein the retaining unit includes a protruding portion, and the protruding portion passes through a hole provided in the receiving unit.

6. The lighting device according to claim 1,
wherein the receiving unit includes a protruding portion, and the protruding portion passes through a hole provided in the retaining unit.

7. The lighting device according to claim 1,
wherein the receiving unit is a magnetic material, and the retaining unit is a magnet.

8. The lighting device according to claim 3,
wherein the protruding portion is provided with a spacer between the retaining unit and the receiving unit.

9. The lighting device according to claim 3,
wherein the protruding portion further passes through a film hole provided in the lighting film.

10. The lighting device according to claim 9,
wherein the film hole has a shape having a linear portion along one side in an expansion and contraction direction of the lighting film.

11. The lighting device according to claim 9,
wherein, in the lighting film, a plurality of the film holes are provided at least on one end side in a first direction and another end side in the first direction, and the film hole provided on the one end side in the first direction and the film hole provided on the other end side in the first direction are arranged in a non-axisymmetric manner.

12. The lighting device according to claim 9,
wherein a plurality of the film holes are provided at least on both sides of the lighting film in a second direction, and the film holes provided on the respective sides facing each other are arranged in the non-axisymmetric manner.

13. The lighting device according to claim 1,
wherein a coefficient of thermal expansion of a material used for the retaining unit is closer to a coefficient of thermal expansion of the lighting film than a coefficient of thermal expansion of a material used for the receiving unit.
